(19) United States
(12) Patent Application Publication
(10) Pub. No.: US 2024/0345225 A1
(43) Pub. Date: Oct. 17, 2024

(54) SCANNING MIRROR-BASED LIDAR DEVICE

(71) Applicant: Wemems Co., Ltd., Buk-gu, Gwangju (KR)

(72) Inventor: Kyoungwoo JO, Gimpo-si, Gyeonggi-do (KR)

(73) Assignee: Wemems Co., Ltd., Buk-gu, Gwangju (KR)

(21) Appl. No.: 18/681,667

(22) PCT Filed: Aug. 8, 2022
(86) PCT No.: PCT/KR2022/011776

§ 371 Date: Feb. 6, 2024

(30) Foreign Application Priority Data
Aug. 9, 2021 (KR) 10-2021-0104336
Aug. 2, 2022 (KR) 10-2022-0096131

(51) Int. Cl. G01S 7/481; G01S 7/4865; G01S 17/10

(52) U.S. Cl. CPC G01S 7/4817; G01S 7/4814; G01S 7/4816; G01S 7/4865; G01S 17/10

(57) ABSTRACT

A scanning mirror-based LiDAR device according to an embodiment of the present invention is characterized by comprising: a light source for generating laser pulses; a first collimation lens for converting the laser pulses to collimated light and emitting same; a scanning mirror which reflects emission light, emitted from the first collimation lens, toward a subject, and re-emits incident light reflected from the subject, by changing the angle of the light via one-way high-speed rotation scanning; a second collimation lens for focusing the light re-emitted from the scanning mirror by changing the angle via the high speed rotation scanning; a plurality of light receiving element arrays which are arranged in the direction perpendicular to the rotation axis of the scanning mirror, and which receive the light focused by the second collimation lens and generate the light as electrical signals; and a signal processor which uses the electrical signals, generated by the plurality of light receiving element arrays, to calculate the measurement distance and measurement time for the subject corresponding to the scanning angle of the scanning mirror. The period of the laser pulses emitted from the light source is shorter than the round-trip time-of-flight of the laser pulses corresponding to the maximum measurement distance of the subject.

### TECHNICAL FIELD

The present disclosure relates to a LiDAR device that acquires surrounding distance information using a laser, and more specifically, to a scanning mirror-based LiDAR device that emits a laser pulse toward a subject and acquires distance information using the time-of-flight of the laser pulse reflected from the subject.

### BACKGROUND ART

Generally, a scanning LiDAR is used to measure an object (target) such as a surrounding terrain, object, or obstacle. Such a scanning LiDAR acquires information about the object by measuring time of flight reflected from the object using a pulse laser. The information about the object acquired through the scanning LiDAR may include information about the existence of the object, the type of the object, the distance to the object, etc.

The scanning LiDAR is used in diverse fields including an automobile, a mobile robot, a ship, a security system, an assembly line, an unmanned aerial vehicle, and a drone. Further, its application field continues to expand.

Meanwhile, the scanning LiDAR using the pulse laser may acquire the distance information of a subject by measuring time between an emitted laser pulse and a reflected laser pulse. At this time, the emission period of the laser pulse is usually set to prevent distance ambiguity from occurring in consideration of the time-of-flight depending on the maximum measurable distance of the subject.

However, in the case of a long-distance subject, the number of points that may be measured per unit time is greatly limited due to the emission of pulses at time intervals that may avoid the distance ambiguity, so that there are limits to increasing spatial resolution.

In order to solve this problem, according to the prior art, a technology has been developed to simultaneously measure multiple points by introducing multiple light sources and light receiving elements. However, this is problematic in that it involves the use of multiple expensive light sources, thereby increasing both the cost and the volume of a device.

### DETAILED DESCRIPTION OF INVENTION

### Technical Problems

Accordingly, the present disclosure has been made keeping in mind the above problems occurring in the prior art, and the present disclosure provides a scanning mirror-based LiDAR device that can increase the number of measurement points per time even during long-distance measurement by alleviating or eliminating distance ambiguity in a scanning LiDAR using a laser pulse.

However, the technical challenge achieved by the present disclosure is not limited to the above-described technical challenge, and there may be additional technical challenges.

### Technical Solution

Among embodiments, a scanning mirror-based LiDAR device may include a light source generating laser pulses: a first collimation lens converting the laser pulses to collimated light and emitting the light: a scanning mirror reflecting emission light, emitted from the first collimation lens, toward a subject, and re-emitting incident light reflected from the subject, by changing an angle of the light via one-way high-speed rotation scanning: a second collimation lens focusing the light re-emitted from the scanning mirror by changing the angle via the high-speed rotation scanning: a plurality of light receiving element arrays arranged in a direction perpendicular to a rotation axis of the scanning mirror, and receiving the light focused by the second collimation lens to generate the light as an electrical signal; and a signal processor using the electrical signal, generated by the plurality of light receiving element arrays, to calculate a measurement distance and measurement time for the subject corresponding to the scanning angle of the scanning mirror, wherein a period of the laser pulse emitted from the light source may be shorter than round-trip time-of-flight of the laser pulse corresponding to a maximum measurement distance of the subject.

Further, n light receiving elements in the plurality of light receiving element arrays may be arranged by allocating n light receiving element channels to correspond to a measurement distance section of the subject.

An interval for each measurement distance section of the subject of the n light receiving element channels may be defined as ΔL.

Further, different circuit gains may be applied to light receiving element signals of the light receiving element channels allocated to each measurement distance section of the plurality of light receiving element arrays.

The period of the laser pulse may be equal to the round-trip time-of-flight, corresponding to the maximum measurement distance of the subject, divided by n.

The device may further include a lens array disposed one-to-one on a front surface of each light receiving element of the plurality of light receiving element arrays.

The lens array may be disposed on the front surface of each light receiving element so that the incident light is focused on an active area of the light receiving element.

The scanning mirror may be a high-speed rotation type using any one of a MEMS mirror, a polygonal mirror, and a galvano mirror.

A scanning mirror-based LiDAR device may include a light source generating laser pulses; a first collimation lens converting the laser pulses to collimated light and emitting the light: a first scanning mirror reflecting emission light, emitted from the first collimation lens, toward a subject, and re-emitting incident light reflected from the subject, by changing an angle of the light via one-way high-speed rotation scanning: a second scanning mirror having a rotation axis that is disposed on a front surface thereof to be perpendicular to a rotation axis of the first scanning mirror, and emitting the light, reflected from the subject, to the first scanning mirror via low-speed rotation scanning: a second collimation lens focusing the light re-emitted from the first scanning mirror by changing the angle via the high-speed rotation scanning: a plurality of light receiving element arrays arranged in a direction perpendicular to the rotation axis of the first scanning mirror, and receiving the light focused by the second collimation lens to generate the light as an electrical signal; and a signal processor using the electrical signal, generated by the plurality of light receiving element arrays, to calculate a measurement distance and measurement time for the subject corresponding to the scanning angle of the first scanning mirror, wherein a period of the laser pulse emitted from the light source may be shorter than round-trip time-of-flight of the laser pulse corresponding to a maximum measurement distance of the subject.

The device may further include a lens array disposed one-to-one on a front surface of each light receiving element of the plurality of light receiving element arrays.

The lens array may be disposed on the front surface of each light receiving element so that the incident light is focused on an active area of the light receiving element.

Further, a size of the first scanning mirror may be smaller than a size of the second scanning mirror.

Further, n light receiving elements in the plurality of light receiving element arrays may be arranged by allocating n light receiving element channels to correspond to a measurement distance section of the subject.

Further, an interval for each measurement distance section of the subject of the n light receiving element channels may be defined as ΔL.

Further, different circuit gains may be applied to light receiving element signals of the light receiving element channels allocated to each measurement distance section of the plurality of light receiving element arrays.

The period of the laser pulse may be equal to the round-trip time-of-flight, corresponding to the maximum measurement distance of the subject, divided by n.

A scanning mirror-based LiDAR device may include a light source generating laser pulses; a first collimation lens converting the laser pulses to collimated light and emitting the light: a scanning mirror reflecting emission light, emitted from the first collimation lens, toward a subject, and re-emitting incident light reflected from the subject, by changing an angle of the light via two-way high-speed rotation scanning: a second collimation lens focusing the light re-emitted from the scanning mirror by changing the angle via the high-speed rotation scanning; a plurality of light receiving element arrays arranged in a direction perpendicular to a rotation axis of the scanning mirror, and receiving the light focused by the second collimation lens to generate the light as an electrical signal; and a signal processor using the electrical signal, generated by the plurality of light receiving element arrays, to calculate a measurement distance and measurement time for the subject corresponding to the scanning angle of the scanning mirror, wherein the plurality of light receiving element arrays may be arranged to be vertically symmetrical with respect to a center of the second collimation lens to correspond to the two-way high-speed rotation scanning of the scanning mirror, and a period of the laser pulse emitted from the light source may be shorter than round-trip time-of-flight of the laser pulse corresponding to a maximum measurement distance of the subject.

The device may further include a lens array disposed one-to-one on a front surface of each light receiving element of the plurality of light receiving element arrays.

The lens array may be disposed on the front surface of each light receiving element so that the incident light is focused on an active area of the light receiving element.

The first scanning mirror may be a high-speed rotation type using any one of a MEMS mirror, a polygonal mirror, and a galvano mirror.

Further, n light receiving elements in the plurality of light receiving element arrays may be arranged by allocating n light receiving element channels to correspond to a measurement distance section of the subject.

Further, an interval for each measurement distance section of the subject of the n light receiving element channels may be defined as ΔL.

Further, different circuit gains may be applied to light receiving element signals of the light receiving element channels allocated to each measurement distance section of the plurality of light receiving element arrays.

The period of the laser pulse may be equal to the round-trip time-of-flight, corresponding to the maximum measurement distance of the subject, divided by n.

### Effect of Invention

According to the present disclosure, it is possible to increase the number of measurement points per time even during long-distance measurement by alleviating or eliminating distance ambiguity in a scanning LiDAR using a laser pulse.

Further, a scanning LiDAR according to the present disclosure can achieve high spatial resolution even when measuring a long-distance subject, thereby allowing the subject to be recognized or perceived with higher accuracy and sensitivity.

Further, according to the present disclosure, measurement accuracy can be improved by applying the gain of a light receiving signal differently according to allocation to each distance section of a light receiving element array.

Further, the number of light sources is minimized, thus improving the price competitiveness of a device, and the volume of the device is small, thus increasing the convenience of application.

### BRIEF DESCRIPTION OF THE DRAWING

FIG. 1 is a schematic view illustrating the configuration of a scanning mirror-based LIDAR device according to a first embodiment of the present disclosure.

FIG. 2 is a diagram illustrating an example of light receiving element channel allocation for each measurement distance section of a light receiving element array according to the present disclosure.

FIG. 3 is a diagram illustrating an example of signal generation time for each light receiving element channel according to the present disclosure.

FIG. 4 is a diagram illustrating an example of increasing the number of measurement points according to the present disclosure.

FIG. 5 is a diagram illustrating an example of gain setting of a light receiving element for each measurement distance section according to the present disclosure.

FIG. 6 is a schematic view illustrating the configuration of a scanning mirror-based LiDAR device according to a second embodiment of the present disclosure.

FIG. 7 is a diagram illustrating an example of the focusing function of a lens array disposed on a front surface of a light receiving element array of FIG. 6.

FIG. 8 is a schematic view illustrating the configuration of a scanning mirror-based LiDAR device according to a third embodiment of the present disclosure.

FIG. 9 is a schematic view illustrating the configuration of a scanning mirror-based LiDAR device according to a fourth embodiment of the present disclosure.

FIG. 10 is a schematic view illustrating the configuration of a scanning mirror-based LiDAR device according to a fifth embodiment of the present disclosure.

FIG. 11 is a schematic view illustrating the configuration of a scanning mirror-based LiDAR device according to a sixth embodiment of the present disclosure.

### BEST MODE FOR CARRYING OUT THE INVENTION

Embodiments of the present disclosure will be described in detail such that those skilled in the art can easily practice the present disclosure. However, the present disclosure may be implemented in various ways without being limited to particular embodiments described herein. In order to clearly explain the present disclosure, parts that are not related to the description will be omitted. Like reference numerals refer to like parts throughout various figures and embodiments of the present disclosure. In addition, when the present disclosure is described with reference to the accompanying drawings, components may be denoted by different reference numerals throughout the drawings even if the components are indicated with the same name. The reference numerals are designated merely for the convenience of description, and the concept, feature, function, or effect of each component is not limited by the reference numerals.

When it is described that a component is “connected” to another component, it should be understood that one component may be directly connected to another component, but that other components may also exist between them. Terms such as “comprise or include” or “have” are intended to specify the existence of implemented features, numbers, steps, operations, components, parts, or combinations thereof unless the context clearly indicates otherwise, but should be understood as not precluding the possibility of the existence or addition of one or more other features, numbers, steps, operations, components, parts, or combinations thereof.

In this specification, terms such as “part” or “module” include a unit implemented by hardware or software, and a unit implemented using both of them. One unit may be realized using two or more hardware, and two or more units may be realized using one hardware.

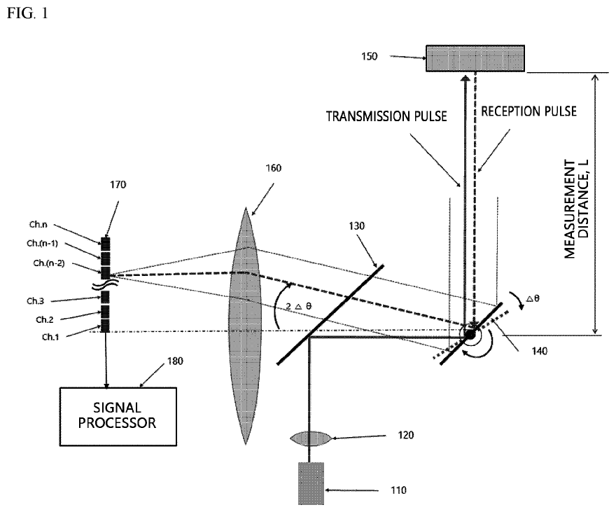

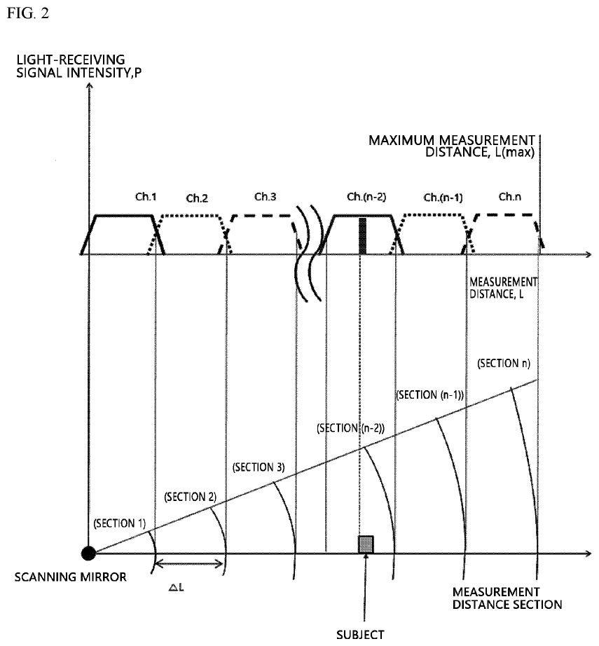

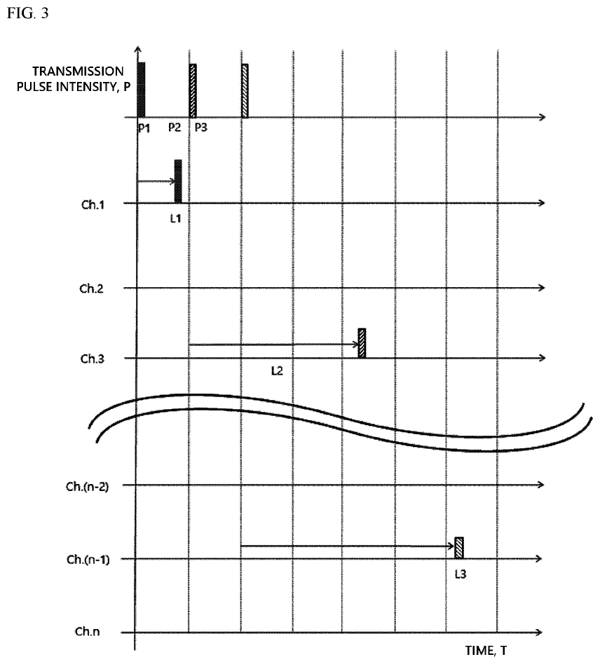

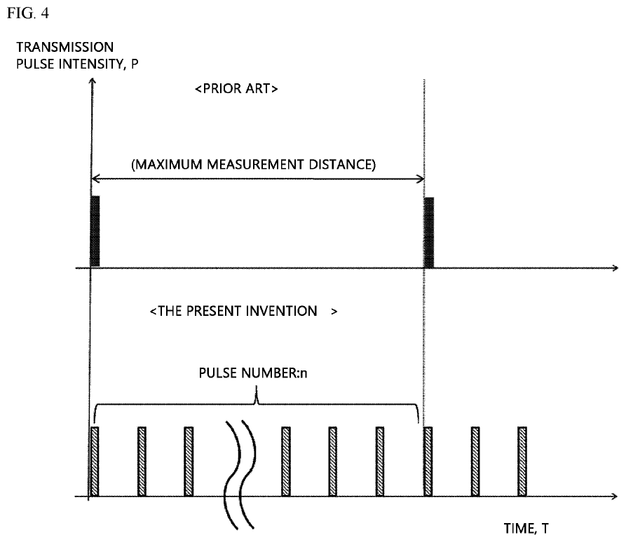

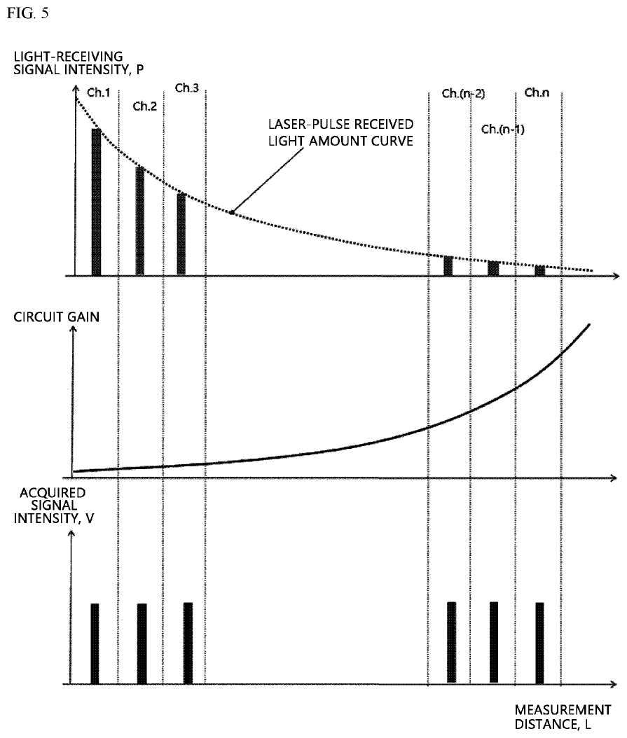

FIG. 1 is a schematic view illustrating the configuration of a scanning mirror-based LiDAR device according to a first embodiment of the present disclosure, FIG. 2 is a diagram illustrating an example of light receiving element channel allocation for each measurement distance section of a light receiving element array according to the present disclosure, FIG. 3 is a diagram illustrating an example of signal generation time for each light receiving element channel according to the present disclosure, FIG. 4 is a diagram illustrating an example of increasing the number of measurement points according to the present disclosure, and FIG. 5 is a diagram illustrating an example of gain setting of a light receiving element for each measurement distance section according to the present disclosure.

As shown in FIG. 1, the scanning mirror-based LiDAR device according to an embodiment of the present disclosure may include a light source 110, a first collimation lens 120, a beam splitter 130, a scanning mirror 140, a second collimation lens 150, and a light receiving element array 170.

The light source 110 is a laser light source that generates a laser pulse, and may be a semiconductor laser or an optical fiber laser. The wavelength of emitted laser may be in the range of 800 nm to 1700 nm.

Further, an output element of the laser light source may include a Laser Diode (LD), a Solid-state laser, a high power laser, a Light entitling diode (LED), a Vertical cavity Surface emitting Laser (VCSEL), an External cavity diode laser (ECDL), and the like but is not limited thereto.

The first collimation lens 120 converts the laser pulse output from the light source to collimated light and emits the light. To be more specific, the first collimation lens 120 reduces the divergence angle of the laser pulse emitted from the light source 110 and converts the laser pulse to nearly collimated light and then emits the light.

The beam splitter 130 serves to separate the paths of emission light and incident light on an optical path between the scanning mirror 140 and the first or second collimation lens 120 or 160. Here, the beam splitter 130 may be a Polarization Beam Splitter (PBS) using polarization, and may include an optical element such as a polarizer or a retarder.

Meanwhile, a mirror that reflects some of the emitted or incident light or an optical circulator may be placed at a location of the beam splitter 130.

The scanning mirror 140 reflects emission light, emitted from the first collimation lens 120, toward a subject 150, and re-emits incident light reflected from the subject 150, by changing an angle of the light via one-way high-speed rotation scanning.

To be more specific, the scanning mirror 140 is a rotary mirror that has the function of changing the angle of the laser pulse incident from the first collimation lens 120 and emitting the laser pulse, and may be a high-speed rotation type such as a MEMS mirror, a polygonal mirror, and a galvano mirror.

Here, the scanning mirror 140 may rotate at a maximum angular velocity range of a high-speed rotation mirror: 360,000 to 36,000,000 deg./sec (corresponding to rotation/vibration frequency, 1 to 100 kHz).

The second collimation lens 160 focuses the light re-emitted from the scanning mirror 140 by changing the angle via the high-speed rotation scanning. In other words, the second collimation lens is a lens that functions to focus incident light reflected from the scanning mirror, and focuses incident light that is close to the collimated light and projects the light onto an active area of the light receiving element. Here, the second collimation lens 160 may be formed using any one of the following materials: organic compounds, glass, quartz, sapphire, single crystal silicon, and germanium, or a composite thereof, but is not limited thereto.

Further, the structure of the second collimation lens 160 may be a spherical or aspherical single lens or composite lens, and may be an f-theta or f-tan (theta) lens, but is not limited thereto.

The plurality of light receiving element arrays 170 are arranged in a direction perpendicular to a rotation axis of the scanning mirror 140, and receive light focused by the second collimation lens to generate an electrical signal.

To be more specific, the plurality of light receiving element arrays 170 arranged in a direction perpendicular to a rotation axis of the high-speed rotation scanning mirror receive reflected incident light to generate an electrical signal.

In this regard, each light receiving element of the plurality of light receiving element arrays 170 may be one of a photodiode, APD, SiPM, and SPAD, and may be one of Si, GaAs, InGaAs, and Ge detectors.

The light receiving elements of the plurality of light receiving element arrays 170 may be a one-dimensional array arranged in a direction perpendicular to the rotation axis of the mirror, and a two-dimensional array added in a direction parallel to the rotation axis of the mirror. Here, the plurality of light receiving element arrays 170 may be formed by assembling individual light receiving elements or be formed as a single chip-type array.

Meanwhile, a detailed description of channel allocation and measurement gain according to the measurement distance of each light receiving element of the plurality of light receiving element arrays 170 will be described later.

The signal processor 180 uses the electrical signal, generated by the plurality of light receiving element arrays 170, to calculate a measurement distance and measurement time for the subject corresponding to the scanning angle of the scanning mirror 140.

To be more specific, the signal processor 180 may include hardware and software to perform the function of processing electrical signals generated from the plurality of light receiving element arrays 170 and calculating a distance for each scan angle.

Here, the signal processor 180 may set circuit gain for amplifying the signals of the light receiving elements to be the same, and may set and process circuit gain differently, such as giving a larger gain value a distance from a main optical axis increases, but is not limited thereto.

In addition, an operation of the above-described scanning mirror-based LiDAR device will be described.

First, after a laser pulse signal emitted from the laser light source 110 passes through the first collimation lens 120, the signal is transmitted to the scanning mirror 140 by the beam splitter 130.

Further, the laser pulse signal reflected by the scanning mirror 140 is reflected by the subject 150, generates a certain time delay, and is transmitted back to the scanning mirror. At this time, due to the scanning mirror 140 rotated in one direction during delay time, a reflection path is changed to have a displaced angle different from that at the time of emission.

Thereafter, the laser pulse signal traveling along the changed angle path is focused by the second collimation lens 160 and arrives at some light receiving element channels of the light receiving element array 170.

The arrived laser pulse signal is generates as an electrical signal in the signal processor 180 to calculate the time-of-flight of the laser pulse signal.

To be more specific, assuming that the angular velocity of the scanning mirror is defined as ω and the subject measurement distance is defined as L, the round-trip time-of-flight to the subject may be defined as Δt=2L/c, the angle of the scanning mirror moved during the time-of-flight may be defined as Δθ=ωΔt, and a change in reception pulse angle may be defined as 2Δθ=2ωΔt. By using these values, the round-trip time-of-flight and measurement distance to the subject of the laser pulse may be calculated.

In other words, the laser pulse incident on the subject is reflected by the subject and then reaches the scanning mirror. At this time, since the mirror rotating at high speed causes angular displacement compared to the time of emission, the reflected laser pulse reaches some of the light receiving elements arranged according to the displaced angle to generate an electrical signal.

When the angular velocity of the rotating scanning mirror is determined, the angular displacement increases in proportion to the round-trip distance, so distance ambiguity is alleviated or eliminated. Thus, the emission period of the laser pulse may become short regardless of a measurement distance range, thereby increasing the number of measurement points per time.

FIG. 2 shows channel allocation for each measurement distance section of each light receiving element of the plurality of light receiving element arrays 170. Here, a distance between respective channels may be expressed as a measurement distance section ΔL, and the maximum measurement distance may be expressed as L (max)/n.

At this time, the arrangement of the light receiving elements in the plurality of light receiving element arrays 170 limits the light receiving condition according to a certain distance range. Conversely, the distance range is set according to the location of the light receiving element.

To be more specific, the pulse signals arrive at the light receiving elements of different channels due to a change in light receiving path depending on the measurement distance of the subject. In this case, the section of a corresponding measurement distance varies depending on the size of the plurality of light receiving element arrays 170.

Further, since the laser pulse received by each light receiving element of the plurality of light receiving element arrays 170 is a spot with a certain diameter, an intensity increases or decreases at a boundary, and intensities may alternate between two neighboring light receiving elements.

In the plurality of light receiving element arrays 170, a light receiving signal generated by the subject at a specific distance may arrive at the light receiving element of a specific channel corresponding to an associated distance section to generate an electrical signal.

FIG. 3 shows a signal generation time for each light receiving element channel. This shows an example where a transmission pulse is emitted at a certain period, reflected from three different points, and then is received by the channel allocated to each distance section.

To be more specific, it can be seen in FIG. 3 that subject distances L1, L2, and L3 (L1<L2<L3) corresponding to consecutive pulses P1, P2, and P3 vary depending on the delay time for each channel (ch. 1, ch.3, ch.(n−1)).

In other words, since a time delay value is measured within a pulse period in each channel and an interval for each distance section is ΔL, a total distance value is calculated by adding a distance ((n−1)ΔL) to a corresponding section.

At this time, the emission time of the transmission pulse may be calculated inversely from the interval ΔL for each distance section to calculate a scan point at an angle corresponding to emission time.

Further, FIG. 4 shows that the number of points which may be measured per unit time when the laser pulse is emitted is increased by a factor of n compared to a conventional number of points.

For example, the conventional scanning LiDAR using the laser pulse emits pulses at a period corresponding to the time-of-flight required to travel the maximum measurement distance for a long-distance subject. That is, after emitting the laser pulse, the laser pulse reflected back from the subject is received and is re-emitted in response to the maximum measurement distance.

According to the present disclosure, when the number of light receiving elements of the plurality of light receiving element arrays is n, the number of channels allocated to each distance is n, and the period of the emitted pulse is equal to the time-of-flight corresponding to the maximum measurement distance divided by n.

Therefore, the period of the laser pulse emitted from the light source may be shorter than the round-trip time-of-flight of the laser pulse corresponding to the maximum measurement distance of the subject, and n laser pulses may be emitted.

Further, FIG. 5 shows the circuit gain of each light receiving element for each measurement distance section. For example, the light-receiving signal intensity and measurement distance for each channel are in inverse proportion. That is, since the light receiving element of ch. 1 has a short measurement distance, the intensity of the reflected light-receiving signal is the highest. In contrast, since the light receiving element of ch. n has a long measurement distance, the intensity of the reflected light-receiving signal is small.

In other words, the intensity of the reflected laser pulse signal according to the measurement distance of the subject is in inverse proportion to the square of distance (P˜1/L²).

Further, a different circuit gain is applied to the light receiving element signal of the light receiving element channel allocated to each measurement distance. Here, the circuit gain may be expressed as the square of the measurement distance (Gain˜L²).

Therefore, the electrical signal obtained from the light receiving element array of the present disclosure can more accurately measure a distance using the above-described standards.

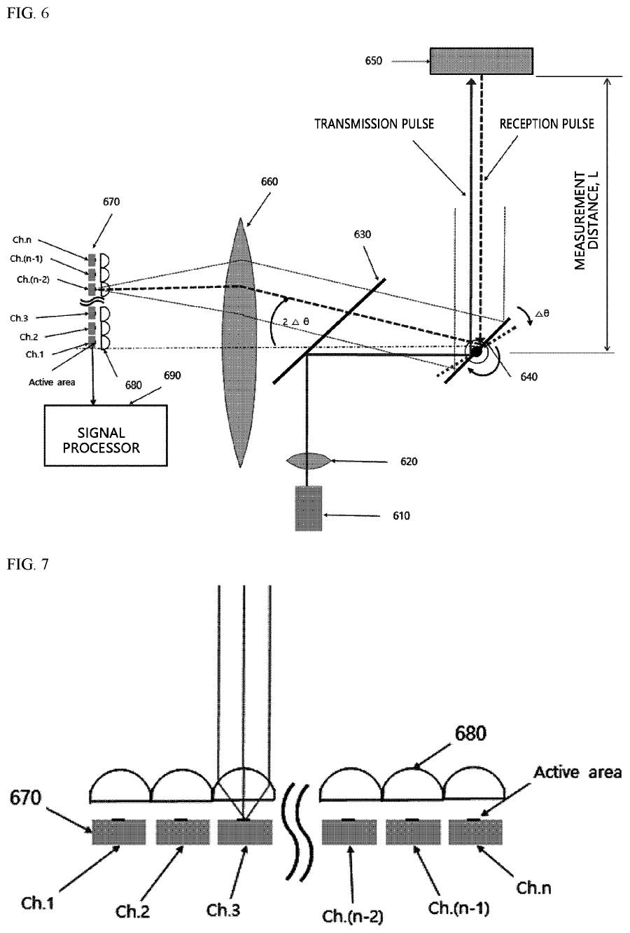

FIG. 6 is a schematic view illustrating the configuration of a scanning mirror-based LiDAR device according to a second embodiment of the present disclosure, and FIG. 7 is a diagram illustrating an example of the focusing function of a lens array disposed on a front surface of a light receiving element array of FIG. 6.

As shown in FIG. 6, the general configuration of the scanning mirror-based LiDAR device according to the second embodiment of the present disclosure remains the same as the first embodiment, but the device further includes a lens array 680 disposed one-to-one on the front surface of each light receiving element of the plurality of light receiving element arrays. Here, the configuration of the second embodiment of the present disclosure that is the same as that of the first embodiment will be omitted by referring to the detailed description of the first embodiment.

To be more specific, the lens array 680 may be further provided on an optical path between a second collimation lens 660 and an active area of the light receiving element.

Here, the number and interval of lenses of the lens array 680 are the same as those of a light receiving element array 670, and the center of an individual lens may be aligned with or offset from the center of the active area of the light receiving element.

Further, the lens array 680 may be in the form of an assembled array of individual lenses or in the form of a single chip array.

The lens array 680 is disposed on a front surface of the light receiving element array 670 to focus incident light on the active area of the light receiving element. Therefore, as the lens array 680 is disposed, it is possible to secure an effective response area to the maximum when the area of the active area is smaller than the area of the light receiving element.

As shown in FIG. 7, the lens array 680 is configured so that a lens with a small radius of curvature is disposed on the front surface of the light receiving element, thus causing incident light in an area corresponding to the entire area of the lens to be focused onto the active area of the light receiving element.

In other words, the lens array 680 minimizes the loss of incident light and allows light to reach the active area even if the active area of the light receiving element is smaller than the area of the light receiving element.

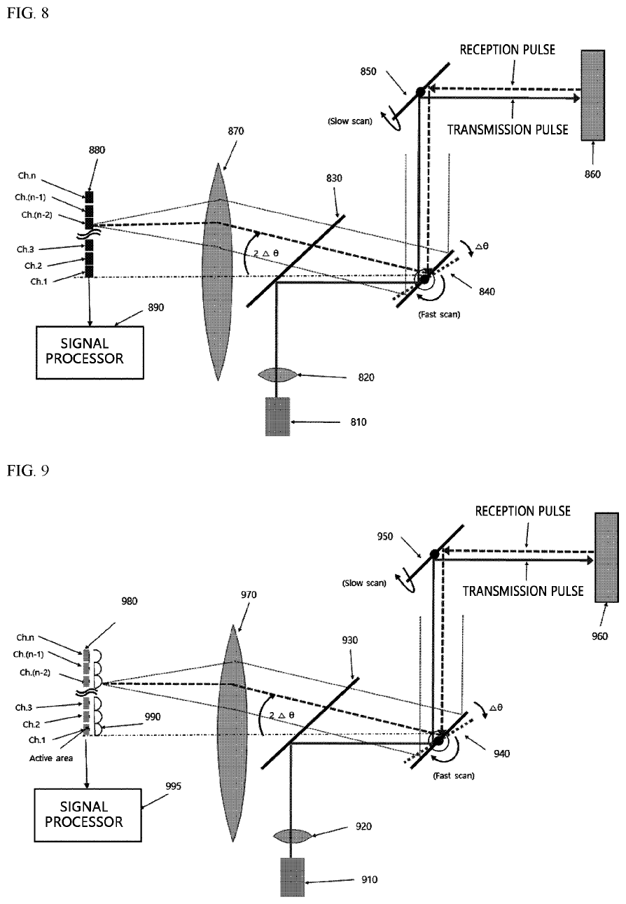

In addition, FIG. 8 is a schematic view illustrating the configuration of a scanning mirror-based LiDAR device according to a third embodiment of the present disclosure. Here, the configuration of the third embodiment of the present disclosure that is the same as that of the first embodiment will be omitted by referring to the detailed description of the first embodiment.

As shown in FIG. 8, the scanning mirror-based LiDAR device according to the third embodiment of the present disclosure may include a light source 810 generating a laser pulse, a first collimation lens 820 converting the laser pulse to collimated light and emitting the light, a first scanning mirror 840 reflecting emission light, emitted from the first collimation lens 820, toward a subject, and re-emitting incident light reflected from the subject, by changing an angle of the light via one-way high-speed rotation scanning, a second scanning mirror 850 having a rotation axis that is disposed on a front surface thereof to be perpendicular to a rotation axis of the first scanning mirror 840 and emitting the light, reflected from the subject, to the first scanning mirror 840 via low-speed rotation scanning, a second collimation lens 870 focusing the light re-emitted from the first scanning mirror 840 by changing the angle via the high-speed rotation scanning, a plurality of light receiving element arrays 880 arranged in a direction perpendicular to the rotation axis of the first scanning mirror 840 and receiving the light focused by the second collimation lens 870 to generate the light as an electrical signal, and a signal processor 890 using the electrical signal, generated by the plurality of light receiving element arrays 880, to calculate a measurement distance and measurement time for the subject corresponding to the scanning angle of the first scanning mirror 840.

To be more specific, the scanning mirror-based LiDAR device according to the third embodiment of the present disclosure is configured to include the first scanning mirror 840 and the second scanning mirror 850 for two-axis scanning. Here, the rotation axes of the first scanning mirror 840 and the second scanning mirror 850 are arranged perpendicular to each other, thus enabling two-axis scanning.

Further, the size of the first scanning mirror 840 is smaller than the size of the second scanning mirror 850, the first scanning mirror 840 rotates at high speed, and the second scanning mirror 850 rotates at low speed. That is, the small first scanning mirror rotates rapidly, while the large second scanning mirror rotates slowly.

FIG. 9 is a schematic view illustrating the configuration of a scanning mirror-based LiDAR device according to a fourth embodiment of the present disclosure. Here, the configuration of the fourth embodiment of the present disclosure that is the same as that of the first and third embodiments will be omitted by referring to the detailed description of the first and third embodiments.

As shown in FIG. 9, the general configuration of the scanning mirror-based LiDAR device according to the fourth embodiment remains the same as the third embodiment, but the device further includes a lens array 990 disposed one-to-one on the front surface of each light receiving element of a plurality of light receiving element arrays 980.

That is, the lens array 990 is disposed on the front surface of the light receiving element array 980 to focus incident light on the active area of the light receiving element. Therefore, as the lens array 990 is disposed, it is possible to secure an effective response area to the maximum when the area of the active area is smaller than the area of the light receiving element.

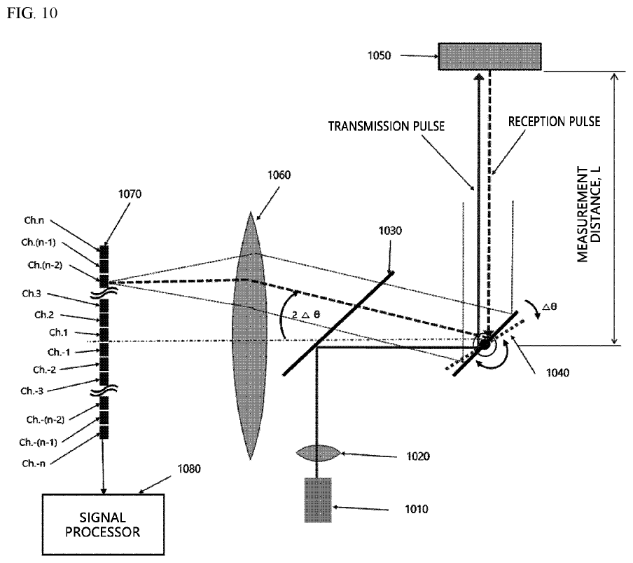

FIG. 10 is a schematic view illustrating the configuration of a scanning mirror-based LiDAR device according to a fifth embodiment of the present disclosure. Here, the configuration of the fifth embodiment of the present disclosure that is the same as that of the first embodiment will be omitted by referring to the detailed description of the first embodiment.

As shown in FIG. 10, the scanning mirror-based LiDAR device according to the fifth embodiment of the present disclosure may include a light source 1010 generating a laser pulse, a first collimation lens 1020 converting the laser pulse to collimated light and emitting the light, a scanning mirror 1040 reflecting emission light, emitted from the first collimation lens 1020, toward a subject and re-emitting incident light reflected from the subject, by changing an angle of the light via two-way high-speed rotation scanning, a second collimation lens 1060 focusing the light re-emitted from the scanning mirror 1040 by changing the angle via the high-speed rotation scanning, a plurality of light receiving element arrays 1070 arranged in a direction perpendicular to a rotation axis of the scanning mirror 1040 and receiving the light focused by the second collimation lens to generate the light as an electrical signal, and a signal processor 1080 using the electrical signal, generated by the plurality of light receiving element arrays 1070, to calculate a measurement distance and measurement time for the subject corresponding to the scanning angle of the scanning mirror 1040. The plurality of light receiving element arrays 1070 may be arranged to be vertically symmetrical with respect to a center of the second collimation lens 1060 to correspond to the two-way high-speed rotation scanning of the scanning mirror 1040.

To be more specific, the scanning mirror-based LiDAR device according to the fifth embodiment of the present disclosure is configured to rotate the scanning mirror 1040 in both directions.

Further, in order to correspond to the bidirectional rotation of the scanning mirror 1040, twofold light receiving element arrays 1070 may be arranged to be symmetrical about a reference location.

That is, when the scanning mirror 1040 rotates in one of both directions, the laser pulse may be received by the light receiving element for each channel in the light receiving element array 1070 disposed above the center of the second collimation lens 1060. In contrast, when the scanning mirror 1040 rotates in the other direction, the laser pulse may be received by the light receiving element for each channel in the light receiving element array 1070 disposed below the center of the second collimation lens 1060. That is, since the angle of the reflected laser pulse varies depending on the rotating direction of the scanning mirror 1040, a location where light is received may also change. In order to receive this light, the light receiving element arrays 1070 are arranged to be vertically symmetrical.

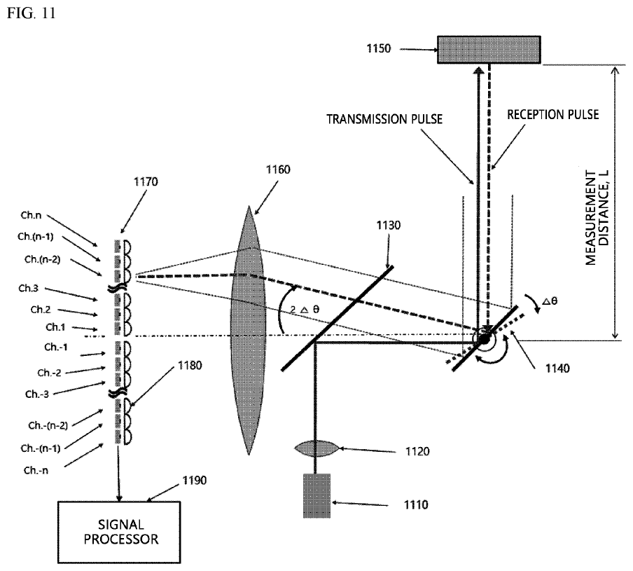

FIG. 11 is a schematic view illustrating the configuration of a scanning mirror-based LiDAR device according to a sixth embodiment of the present disclosure. Here, the configuration of the sixth embodiment of the present disclosure that is the same as that of the fifth embodiment will be omitted by referring to the detailed description of the first and fifth embodiments.

As shown in FIG. 11, the general configuration of the scanning mirror-based LiDAR device according to the sixth embodiment remains the same as the fifth embodiment, but the device further includes a lens array 1180 disposed one-to-one on the front surface of each light receiving element of a plurality of light receiving element arrays 1170.

That is, the lens array 1180 is disposed on the front surface of the light receiving element array 1170 to focus incident light on the active area of the light receiving element. Therefore, as the lens array 1180 is disposed, it is possible to secure an effective response area to the maximum when the area of the active area is smaller than the area of the light receiving element.

Therefore, according to the present disclosure described above, the emission period of a laser pulse is set to be short regardless of the range of a measurement distance, thus alleviating or eliminating distance ambiguity, and increasing the number of points that may be measured per time even during long-distance measurement.

The foregoing is for illustrative purpose, and those skilled in the art will understand that the present disclosure can be easily changed in various forms without changing the technical idea or essential features of the present disclosure. Therefore, the above-described embodiments should be understood in all respects as illustrative and not restrictive. For example, each component described as unitary may be implemented in a distributed form. Likewise, components described as distributed may be implemented in a combined form.

Although the present disclosure has been described above with reference to preferred embodiments, it will understood by those skilled in the art that various modifications and changes may be made to the present disclosure without departing from the idea and scope of the present disclosure as set forth in the following claims.

### DESCRIPTION OF REFERENCE NUMERALS

110, 610, 810, 910, 1010, 1110: light source
120, 620, 820, 920, 1020, 1120: first collimation lens
130, 630, 830, 930, 1030, 1130: beam splitter
140, 640, 1040, 1140: scanning mirror
840, 940: first scanning mirror
850, 950: second scanning mirror
150, 650, 860, 960, 1050, 1150: subject
160. 660, 870, 970, 1060, 1160: second collimation lens
170, 670, 880, 980, 1070, 1170: light receiving element array
180, 680, 890, 995, 1080, 1190: signal processor
680, 990, 1180: lens array

What is claimed is:

1. A scanning mirror-based LiDAR device comprising:
a light source generating laser pulses;
a first collimation lens converting the laser pulses to collimated light and emitting the light;
a scanning mirror reflecting emission light, emitted from the first collimation lens, toward a subject, and re-emitting incident light reflected from the subject, by changing an angle of the light via one-way high-speed rotation scanning;
a second collimation lens focusing the light re-emitted from the scanning mirror by changing the angle via the high-speed rotation scanning;
a plurality of light receiving element arrays arranged in a direction perpendicular to a rotation axis of the scanning mirror, and receiving the light focused by the second collimation lens to generate the light as an electrical signal; and
a signal processor using the electrical signal, generated by the plurality of light receiving element arrays, to calculate a measurement distance and measurement time for the subject corresponding to the scanning angle of the scanning mirror,
wherein a period of the laser pulse emitted from the light source is shorter than round-trip time-of-flight of the laser pulse corresponding to a maximum measurement distance of the subject.

2. The scanning mirror-based LiDAR device of claim 1, wherein n light receiving elements in the plurality of light receiving element arrays are arranged by allocating n light receiving element channels to correspond to a measurement distance section of the subject.

3. The scanning mirror-based LiDAR device of claim 2, wherein an interval for each measurement distance section of the subject of the n light receiving element channels is defined as ΔL.

4. The scanning mirror-based LiDAR device of claim 2, wherein different circuit gains are applied to light receiving element signals of the light receiving element channels allocated to each measurement distance section of the plurality of light receiving element arrays.

5. The scanning mirror-based LiDAR device of claim 1, wherein the period of the laser pulse is equal to the round-trip time-of-flight, corresponding to the maximum measurement distance of the subject, divided by n.

6. The scanning mirror-based LiDAR device of claim 1, further comprising:
a lens array disposed one-to-one on a front surface of each light receiving element of the plurality of light receiving element arrays.

7. The scanning mirror-based LiDAR device of claim 6, wherein the lens array is disposed on the front surface of each light receiving element so that the incident light is focused on an active area of the light receiving element.

8. The scanning mirror-based LiDAR device of claim 1, wherein the scanning mirror is a high-speed rotation type using any one of a MEMS mirror, a polygonal mirror, and a galvano mirror.

9. A scanning mirror-based LiDAR device comprising:
a light source generating laser pulses;
a first collimation lens converting the laser pulses to collimated light and emitting the light;
a first scanning mirror reflecting emission light, emitted from the first collimation lens, toward a subject, and re-emitting incident light reflected from the subject, by changing an angle of the light via one-way high-speed rotation scanning;
a second scanning mirror having a rotation axis that is disposed on a front surface thereof to be perpendicular to a rotation axis of the first scanning mirror, and emitting the light, reflected from the subject, to the first scanning mirror via low-speed rotation scanning;
a second collimation lens focusing the light re-emitted from the first scanning mirror by changing the angle via the high-speed rotation scanning;
a plurality of light receiving element arrays arranged in a direction perpendicular to the rotation axis of the first scanning mirror, and receiving the light focused by the second collimation lens to generate the light as an electrical signal; and
a signal processor using the electrical signal, generated by the plurality of light receiving element arrays, to calculate a measurement distance and measurement time for the subject corresponding to the scanning angle of the first scanning mirror,
wherein a period of the laser pulse emitted from the light source is shorter than round-trip time-of-flight of the laser pulse corresponding to a maximum measurement distance of the subject.

10. The scanning mirror-based LiDAR device of claim 9, further comprising:
a lens array disposed one-to-one on a front surface of each light receiving element of the plurality of light receiving element arrays.

11. The scanning mirror-based LiDAR device of claim 10, wherein the lens array is disposed on the front surface of each light receiving element so that the incident light is focused on an active area of the light receiving element.

12. The scanning mirror-based LiDAR device of claim 9, wherein a size of the first scanning mirror is smaller than a size of the second scanning mirror.

13. The scanning mirror-based LiDAR device of claim 9, wherein n light receiving elements in the plurality of light receiving element arrays are arranged by allocating n light receiving element channels to correspond to a measurement distance section of the subject.

14. The scanning mirror-based LiDAR device of claim 13, wherein an interval for each measurement distance section of the subject of the n light receiving element channels is defined as ΔL.

15. The scanning mirror-based LiDAR device of claim 13, wherein different circuit gains are applied to light receiving element signals of the light receiving element channels allocated to each measurement distance section of the plurality of light receiving element arrays.

16. The scanning mirror-based LiDAR device of claim 9, wherein the period of the laser pulse is equal to the round-trip time-of-flight, corresponding to the maximum measurement distance of the subject, divided by n.

17. A scanning mirror-based LiDAR device comprising:
a light source generating laser pulses;
a first collimation lens converting the laser pulses to collimated light and emitting the light:
a scanning mirror reflecting emission light, emitted from the first collimation lens, toward a subject, and re-emitting incident light reflected from the subject, by changing an angle of the light via two-way high-speed rotation scanning;
a second collimation lens focusing the light re-emitted from the scanning mirror by changing the angle via the high-speed rotation scanning;
a plurality of light receiving element arrays arranged in a direction perpendicular to a rotation axis of the scanning mirror, and receiving the light focused by the second collimation lens to generate the light as an electrical signal; and
a signal processor using the electrical signal, generated by the plurality of light receiving element arrays, to calculate a measurement distance and measurement time for the subject corresponding to the scanning angle of the scanning mirror,
wherein the plurality of light receiving element arrays are arranged to be vertically symmetrical with respect to a center of the second collimation lens to correspond to the two-way high-speed rotation scanning of the scanning mirror, and
wherein a period of the laser pulse emitted from the light source is shorter than round-trip time-of-flight of the laser pulse corresponding to a maximum measurement distance of the subject.

18. The scanning mirror-based LiDAR device of claim 17, further comprising:
a lens array disposed one-to-one on a front surface of each light receiving element of the plurality of light receiving element arrays.

19. The scanning mirror-based LiDAR device of claim 18, wherein the lens array is disposed on the front surface of each light receiving element so that the incident light is focused on an active area of the light receiving element.

20. The scanning mirror-based LiDAR device of claim 17, wherein the first scanning mirror is a high-speed rotation type using any one of a MEMS mirror, a polygonal mirror, and a galvano mirror.

21. The scanning mirror-based LiDAR device of claim 17, wherein n light receiving elements in the plurality of light receiving element arrays are arranged by allocating n light receiving element channels to correspond to a measurement distance section of the subject.

22. The scanning mirror-based LiDAR device of claim 21, wherein an interval for each measurement distance section of the subject of the n light receiving element channels is defined as ΔL.

23. The scanning mirror-based LiDAR device of claim 21, wherein different circuit gains are applied to light receiving element signals of the light receiving element channels allocated to each measurement distance section of the plurality of light receiving element arrays.

24. The scanning mirror-based LiDAR device of claim 17, wherein the period of the laser pulse is equal to the round-trip time-of-flight, corresponding to the maximum measurement distance of the subject, divided by n.
